(19) United States
(12) Patent Application Publication
(10) Pub. No.: US 2026/0136438 A1
(43) Pub. Date: May 14, 2026

(54) COOKING DEVICE AND CONTROL METHOD THEREFOR

(71) Applicant: Samsung Electronics Co., Ltd., Suwon-si (KR)

(72) Inventors: Jaeyong KO, Suwon-si (KR); Haeseung LEE, Suwon-si (KR); Hyunjoon CHOO, Suwon-si (KR); Jungsu HA, Suwon-si (KR); Jonghun HA, Suwon-si (KR)

(21) Appl. No.: 19/443,658

(22) Filed: Jan. 8, 2026

Related U.S. Application Data
(63) Continuation of application No. PCT/KR2024/010052, filed on Jul. 12, 2024.

(30) Foreign Application Priority Data
Aug. 31, 2023 (KR) 10-2023-0115864
Sep. 4, 2023 (KR) 10-2023-0117302
Feb. 1, 2024 (KR) 10-2024-0015906
Mar. 22, 2024 (KR) 10-2024-0039636
Apr. 2, 2024 (KR) 10-2024-0044993

(51) Int. Cl. H05B 6/12; F24C 7/08; H05B 6/06

(52) U.S. Cl. CPC H05B 6/1236; F24C 7/083; H05B 6/06; H05B 2213/07

(57) ABSTRACT

A cooking appliance is provided. The cooking appliance includes a top plate including a heating zone, an induction coil aligned with the heating zone, an acceleration sensor coupled to the top plate, an arithmetic unit for processing sensing data detected by the acceleration sensor, and a processor for controlling the induction coil, the acceleration sensor, and the arithmetic unit, wherein the processor is configured to, while the induction coil heats a cooking vessel on the heating zone detect, by the acceleration sensor, a vibration level with respect to the top plate, obtain, by the arithmetic unit, data associated with a frequency spectrum of the detected vibration level, determine at least one reference value for a specific frequency spectrum based on the obtained data, based on the determined at least one reference value, evaluate data associated with a frequency spectrum obtained after determining the at least one reference value, identify boiling of a substance in the cooking vessel based on the evaluation, and control the induction coil based on the identification.

### CROSS-REFERENCE TO RELATED APPLICATION(S)

This application is a continuation application, claiming priority under 35 U.S.C. § 365(c), of an International application No. PCT/KR2024/010052, filed on Jul. 12, 2024, which is based on and claims the benefit of a Korean patent application number 10-2023-0115864, filed on Aug. 31, 2023, in the Ministry of Intellectual Property, of a Korean patent application number 10-2023-0117302, filed on Sep. 4, 2023, in the Ministry of Intellectual Property, of a Korean patent application number 10-2024-0015906, filed on Feb. 1, 2024, in the Ministry of Intellectual Property, of a Korean patent application number 10-2024-0039636, filed on Mar. 22, 2024, in the Ministry of Intellectual Property, and of a Korean patent application number 10-2024-0044993, filed on Apr. 2, 2024, in the Ministry of Intellectual Property, the disclosure of each of which is incorporated by reference herein in its entirety.

### BACKGROUND

### 1. Field

The disclosure relates to a cooking device and a control method therefor.

### 2. Description of Related Art

A cooking appliance such as an induction hob may heat food by utilizing the principle of electromagnetic induction. Unlike a conventional an electric or gas cooktop that relies on direct heat transfer from an electric coil or a flame, the induction hob uses an induction coil disposed below the cooking appliance. The induction coil may generate a magnetic field by applied AC. This magnetic field may induce an eddy current in a ferromagnetic cooking vessel placed above the hob. As a result, due to a resistance of metal with respect to the induced current, the cooking appliance itself may become a heat source and may heat food quickly and efficiently.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a cooking device and a control method therefor.

Additional aspects will be set forth in part in the description which follows and, in part, will be apparent from the description, or may be learned by practice of the presented embodiments.

In accordance with an aspect of the disclosure, a cooking appliance is provided. The cooking appliance includes a top plate including a heating zone, an induction coil aligned with the heating zone, an acceleration sensor coupled to the top plate, an arithmetic unit for processing sensing data detected by the acceleration sensor, and a processor for controlling the induction coil, the acceleration sensor, and the arithmetic unit, wherein the processor is configured to, while the induction coil heats a cooking vessel on the heating zone, detect, by the acceleration sensor, a vibration level with respect to the top plate, obtain, by the arithmetic unit, data associated with a frequency spectrum of the detected vibration level, determine at least one reference value for a specific frequency spectrum based on the obtained data, based on the determined at least one reference value, evaluate data associated with a frequency spectrum obtained after determining the at least one reference value, identify boiling of a substance in the cooking vessel based on the evaluation, and control the induction coil based on the identification.

In accordance with another aspect of the disclosure, a method of controlling a cooking appliance is provided. The method includes heating a cooking vessel on a top plate via an induction coil, obtaining data associated with a frequency spectrum of a vibration level for the top plate while heating the cooking vessel, determining at least one reference value for a specific frequency spectrum based on the obtained data, based on the determined at least one reference value, evaluating data associated with a frequency spectrum obtained after determining the at least one reference value, identifying boiling of a substance in the cooking vessel based on the evaluation, and controlling the induction coil based on the identification.

In accordance with another aspect of the disclosure, a cooking appliance is provided. The cooking appliance includes a top plate including a heating zone, an induction coil aligned with the heating zone, at least one sensor, memory including at least one storage medium storing instructions, and a processor including processing circuitry. The instructions, when executed individually or collectively by the processor, cause the cooking appliance to heat a cooking vessel on the heating zone of the top plate via the induction coil. The instructions, when executed individually or collectively by the processor, cause the cooking appliance to detect boiling of a substance in the cooking vessel and a temperature of the heating zone of the top plate by using the at least one sensor while heating the cooking vessel. The instructions, when executed individually or collectively by the processor, cause the cooking appliance to change a heating level of the cooking appliance based on a timing at which the boiling is detected or the temperature detected at the timing.

In accordance with another aspect of the disclosure, a method of controlling a cooking appliance is provided. The method includes heating a cooking vessel on the top plate via an induction coil below the top plate, while heating the cooking vessel, detecting boiling of a substance in the cooking vessel using an acceleration sensor and detecting a temperature corresponding to the substance in the cooking vessel using a temperature sensor, and changing a heating level of the cooking vessel based on a timing at which the boiling is detected and the temperature detected at the timing using the temperature sensor.

In accordance with another embodiment aspect of the disclosure, one or more non-transitory computer-readable storage media storing one or more computer programs including computer-executable instructions that, when executed by one or more processors of a cooking appliance individually or collectively, cause the cooking appliance to perform operations are provided. The operations include heating a cooking vessel on a top plate via an induction coil, obtaining data associated with a frequency spectrum of a vibration level for the top plate while heating the cooking vessel, determining at least one reference value for a specific frequency spectrum based on the obtained data, based on the determined at least one reference value, evaluating data associated with a frequency spectrum obtained after determining the at least one reference value, identifying boiling of a substance in the cooking vessel based on the evaluation, and controlling the induction coil based on the identification.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a top plan view of a cooking appliance according to an embodiment of the disclosure;

FIG. 2 is a top plan view of a cooking appliance according to an embodiment of the disclosure;

FIG. 3 is a diagram indicating a configuration of a cooking appliance according to an embodiment of the disclosure;

FIG. 4 is a flowchart for indicating a method of operating a cooking appliance according to an embodiment of the disclosure;

FIG. 5 is a flowchart for indicating a method of operating a cooking appliance according to an embodiment of the disclosure;

FIG. 6 is a graph indicating data associated with a frequency spectrum according to an embodiment of the disclosure;

FIG. 7 is a flowchart for describing an operation of a cooking appliance according to an embodiment of the disclosure;

FIG. 8 is a flowchart for describing an operation of a cooking appliance according to an embodiment of the disclosure;

FIG. 9 is a flowchart for describing an operation of a cooking appliance according to an embodiment of the disclosure;

FIG. 10 is a flowchart for describing an operation of a cooking appliance according to an embodiment of the disclosure;

FIG. 11 is a flowchart for describing an operation of a cooking appliance according to an embodiment of the disclosure;

FIG. 12 is a flowchart for describing an operation of a cooking appliance according to an embodiment of the disclosure;

FIG. 13 is a flowchart for describing an operation of a cooking appliance according to an embodiment of the disclosure;

FIG. 14 is a flowchart for describing an operation of a cooking appliance according to an embodiment of the disclosure;

FIG. 15 is a diagram indicating a configuration of a cooking appliance according to an embodiment of the disclosure;

FIG. 16 is a graph indicating a temperature of a cooking appliance according to a heating time according to an embodiment of the disclosure;

FIG. 17 is a graph indicating a temperature of a cooking appliance according to a heating time according to an embodiment of the disclosure;

FIG. 18 is a graph indicating a temperature of a cooking appliance according to a heating time according to an embodiment of the disclosure;

FIG. 19 is a graph indicating a temperature of a cooking appliance according to a heating time according to an embodiment of the disclosure;

FIG. 20 is a flowchart indicating an operation of a cooking appliance for controlling a heat level according to an embodiment of the disclosure;

FIG. 21 is a flowchart indicating an operation of a cooking appliance for controlling a heat level according to an embodiment of the disclosure;

FIG. 22 is a flowchart indicating an operation of a cooking appliance for controlling a heat level according to an embodiment of the disclosure;

FIG. 23 is a flowchart indicating an operation of a cooking appliance for controlling a heat level according to an embodiment of the disclosure;

FIG. 24A is a diagram indicating a panel of a cooking appliance according to an embodiment of the disclosure;

FIG. 24B is a diagram indicating a panel of a cooking appliance according to an embodiment of the disclosure;

FIG. 24C is a diagram indicating a panel of a cooking appliance according to an embodiment of the disclosure;

FIG. 24D is a diagram indicating a panel of a cooking appliance according to an embodiment of the disclosure; and

FIG. 24E is a diagram indicating a panel of a cooking appliance according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, an expression “at least one of a, b, or c” may refer to “a,” “b,” “c,” “a and b,” “a and c,” “b and c,” “a, b, and c,” or variations thereof.

Throughout the disclosure, when a portion is said to “include” an element, this means, unless particularly stated otherwise, that the portion does not exclude another element but may further include another element. In addition, terms such as “ . . . unit” and “module” described in the disclosure refer to units that process at least one function or operation, and these may be implemented as hardware, software, or a combination of hardware and software.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

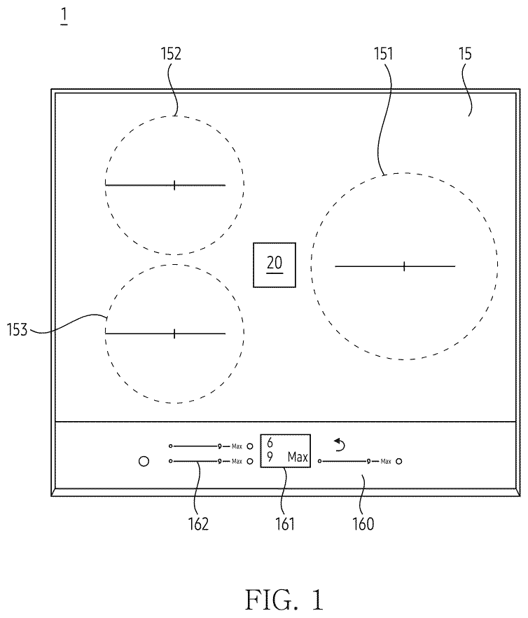

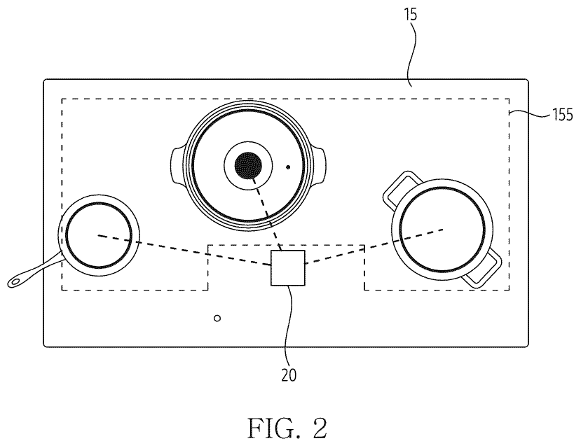

FIGS. 1 and 2 are top plan views of a cooking appliance according to various embodiments of the disclosure.

Referring to FIG. 1, a cooking appliance 1 according to an embodiment may include an induction hob. For example, the cooking appliance 1 may include a top plate 15. The top plate 15 may include a heating zone (a cooking zone or a burner). For example, the top plate 15 may include a first heating zone 151, a second heating zone 152, and a third heating zone 153.

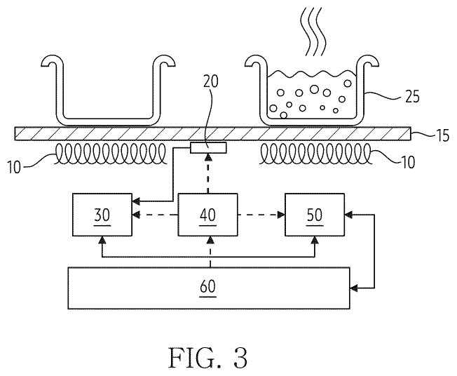

In an embodiment, the cooking appliance 1 may include a sensor 20. The sensor 20 may be positioned substantially in the middle of the first heating zone 151, the second heating zone 152, and the third heating zone 153. Accordingly, the sensor 20 may improve relative accuracy of values detected for the first heating zone 151, the second heating zone 152, and the third heating zone 153. Although not illustrated, the cooking appliance 1 may include induction coils (e.g., an induction coil 10 of FIG. 3) respectively aligned with the first heating zone 151, the second heating zone 152, and the third heating zone 153.

In an embodiment, the cooking appliance 1 may include a panel (or a user interface) 160 disposed on the top plate 15. For example, the panel 160 may include a display 161 for indicating various information, such as an operation state of the cooking appliance 1, and buttons 162 for a user to control the cooking appliance 1. The panel 160 may be configured to detect a touch input of the user, and the buttons 162 may be implemented as soft buttons operated by the touch input, but are not limited thereto. For example, at least a portion of the buttons 162 may be implemented as physical buttons.

In an embodiment, the cooking appliance 1 may be built-in on a countertop or may be installed in a separate frame.

In FIG. 1, it is illustrated that the top plate 15 includes three divided heating zones 151, 152, and 153, but is not limited thereto.

Referring to FIG. 2, the top plate 15 may include one heating zone 155. In this case, the heating zone 155 may occupy most of extent of the top plate 15, and the cooking appliance 1 may heat a cooking vessel placed on the heating zone 155 without limitation in position. For example, the cooking appliance 1 may detect a position of the cooking vessel on the heating zone 155 and may operate an induction coil at a position corresponding to the detected position. Accordingly, the cooking vessel placed at an arbitrary position on the heating zone 155 may be heated. However, it is not limited by the above-described example.

FIG. 3 is a diagram indicating a configuration of a cooking appliance according to an embodiment of the disclosure.

A solid line arrow in FIG. 3 indicates a flow of data, and a dotted arrow indicates a bias voltage. Referring to FIG. 3, a cooking appliance 1 according to an embodiment may include an induction coil 10, a sensor 20, an arithmetic unit 30, a low-dropout regulator 40, a voltage level shifter 50, and a controller 60. In an embodiment, the arithmetic unit 30, the low-dropout (LDO) regulator 40, the voltage level shifter 50, and the controller 60 may be mounted on a printed circuit board.

In an embodiment, the controller 60 may control an overall operation of the cooking appliance 1. The controller 60 may include, for example, a processing device (e.g., processing circuitry) such as a microcontroller and a microprocessor. In an embodiment, the controller 60 may be operatively coupled with the induction coil 10, the sensor 20, the arithmetic unit 30, the LDO regulator 40, and the voltage level shifter 50. For example, the controller 60 may be communicatively connected to the arithmetic unit 30, the LDO regulator 40, and the voltage level shifter 50. For example, the controller 60, the arithmetic unit 30, the LDO regulator 40, and the voltage level shifter 50 may be interconnected through a communication protocol such as an inter-integrated circuit (I2C), a general-purpose input/output (GPIO), or a Universal Asynchronous Receiver-Transmitter (UART), but are not limited thereto.

In an embodiment, the controller 60 may control an alternating current applied to the induction coil 10 through a power device. The induction coil 10 may heat a cooking vessel 25 placed on the top plate 15 (e.g., the heating areas 151, 152, and 153 of FIG. 1). The top plate 15 may be formed of glass and/or ceramic for properties such as durability, heat resistance and permeability to electromagnetic fields.

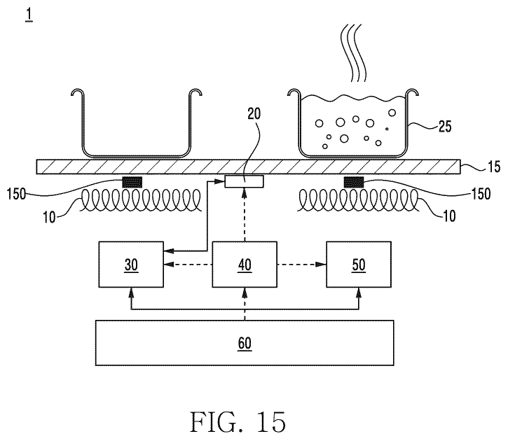

In an embodiment, the sensor 20 may be coupled to a lower portion of the top plate 15. In an embodiment, the sensor 20 may be configured to detect vibration with respect to the top plate 15. For example, the sensor 20 may include an acceleration sensor that measures acceleration (e.g., acceleration in a z-axis direction) for an area of the top plate or a point within the area. In an embodiment, the sensor 20 may transmit acceleration data to the arithmetic unit 30. In order to fully detect the vibration of the top plate 15, the sensor 20 may be attached to a rear surface of the top plate 15 through an adhesive member (e.g., a solid glue). Additionally, the cooking appliance 1 or the sensor 20 may include a temperature sensor (e.g., the temperature sensor 150 of FIG. 15) for detecting a temperature of the top plate 15. For example, the temperature sensor may detect a temperature for each of the heating zones (e.g., the heating zones 151, 152, and 153 of FIG. 1) of the top plate 15.

In an embodiment, the arithmetic unit 30 may include a computing unit such as a micro processing unit (MCU). The arithmetic unit 30 may process data provided from the sensor 20. For example, the arithmetic unit 30 may convert (e.g., fast Fourier transform (FFT)) a vibration level detected by the sensor 20. To this end, the arithmetic unit 30 may support an FFT library module.

In an embodiment, the LDO regulator 40 may regulate an input voltage and provide it to the arithmetic unit 30, the voltage level shifter 50, and the sensor 20.

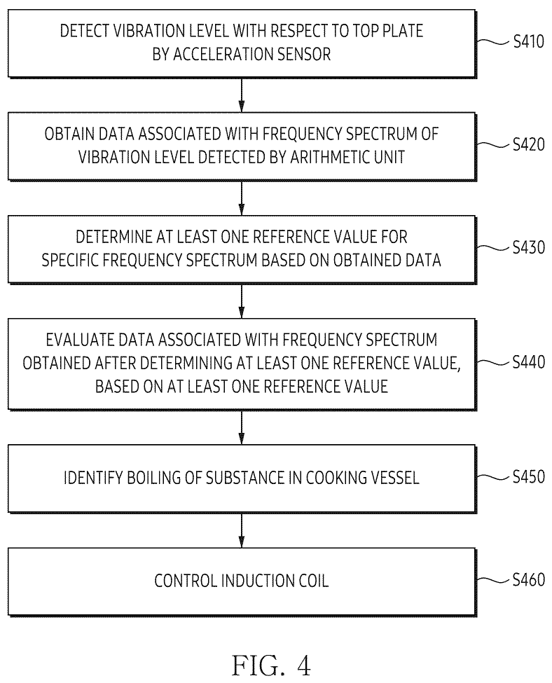

FIG. 4 is a flowchart for indicating a method of operating a cooking appliance according to an embodiment of the disclosure.

Operations illustrated in FIG. 4 and the following drawings may be performed by the cooking appliance 1 or the controller 60 of FIG. 3. The operations illustrated in FIG. 4 and the following drawings may be caused by one or more instructions stored in one or more programs when the one or more programs stored in the cooking appliance 1 are executed by the controller 60. For example, the cooking appliance 1 may include memory including at least one storage medium for storing instructions. The instructions, when executed individually or collectively by the controller 60, may cause the operations of the cooking appliance 1 described in FIG. 4 and the following drawings. The operations illustrated in FIG. 4 and the following drawings may be performed sequentially, in parallel, or substantially simultaneously.

Referring to FIG. 4 together with FIG. 3, in operation S410, the controller 60 may detect a vibration level with respect to a top plate by an acceleration sensor. For example, the controller 60 may enable an induction coil 10 to heat a cooking vessel 25 on a heating zone of a top plate 15. The controller 60 may detect a vibration level with respect to the top plate 15 by an acceleration sensor 20 while heating the cooking vessel 25.

In operation S420, the controller 60 may obtain data associated with a frequency spectrum of the vibration level detected by an arithmetic unit. For example, the controller 60 may obtain data associated with a frequency spectrum of the vibration level detected by an arithmetic unit 30 while the induction coil 10 heats the cooking vessel 25 on the heating zone.

In operation S430, the controller 60 may determine at least one reference value for a specific frequency spectrum based on the obtained data. For example, the controller 60 may determine the at least one reference value for the specific frequency spectrum based on the obtained data.

In operation S440, the controller 60 may evaluate data associated with a frequency spectrum obtained after determining the at least one reference value, based on the at least one reference value.

In operation S450, the controller 60 may identify boiling of a substance in a cooking vessel. For example, the controller 60 may identify boiling of a substance in the cooking vessel 25 based on the evaluation.

In operation S460, the controller 60 may control an induction coil. For example, the controller 60 may control the induction coil 10 based on the identification of the boiling of the substance in the cooking vessel 25.

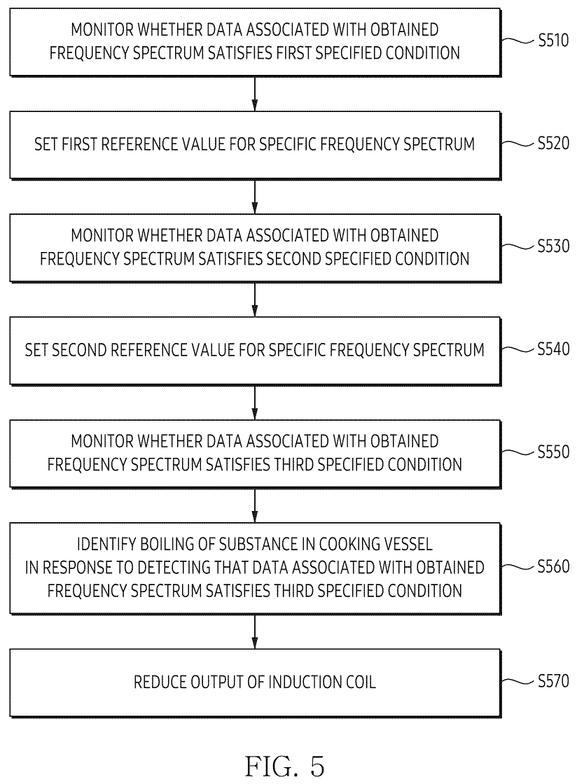

FIG. 5 is a flowchart for indicating a method of operating a cooking appliance according to an embodiment of the disclosure.

Operations S510, S520, S530, and S540 of FIG. 5 may be detailed operations of the operation S430 of FIG. 4. Operation S550 of FIG. 5 may be a detailed operation of the operation S440 of FIG. 4. Operation S560 of FIG. 5 may be a detailed operation of the operation S450 of FIG. 4. Operation S570 of FIG. 5 may be a detailed operation of the operation S460 of FIG. 4.

Referring to FIG. 5 together with FIG. 3, in operation S510, a controller 60 may monitor whether data associated with an obtained frequency spectrum satisfies a first specified condition. For example, the controller 60 may monitor whether the data associated with the obtained frequency spectrum satisfies the first specified condition.

In operation S520, the controller 60 may set a first reference value for a specific frequency spectrum. For example, the controller 60 may determine the data associated with the frequency spectrum that satisfies the specified condition as the first reference value for the specific frequency spectrum.

In operation S530, the controller 60 may monitor whether data associated with an obtained frequency spectrum satisfies a second specified condition. For example, the controller 60 may monitor whether data associated with a frequency spectrum obtained after determining the first reference value satisfies the second specified condition.

In operation S540, the controller 60 may set a second reference value for a specific frequency spectrum. For example, the controller 60 may determine data associated with the frequency spectrum that satisfies the second specified condition as the second reference value for the specific frequency spectrum. The second reference value may be different from the first reference value.

In operation S550, the controller 60 may monitor whether data associated with an obtained frequency spectrum satisfies a third specified condition. For example, the controller 60 may monitor whether data associated with a frequency spectrum obtained after determining the second reference value satisfies the third specified condition. The third specified condition may be, for example, a condition based at least on the first reference value and the second reference value. The third specified condition may be, for another example, based on the first reference value, the second reference value, and a temperature of a top plate. In this case, the controller 60 may detect a temperature of a top plate 15 by a temperature sensor after determining the second reference value in order to monitor whether the third specified condition is satisfied in operation S550.

In operation S560, the controller 60 may identify boiling of a substance in a cooking vessel 25 in response to detecting that the data associated with the obtained frequency spectrum satisfies the third specified condition.

In operation S570, the controller 60 may reduce an output of an induction coil. For example, the controller 60 may reduce an output of an induction coil 10 in response to identifying the boiling of the substance in the cooking vessel 25. For example, the controller 60 may reduce a power supplied to the induction coil 10.

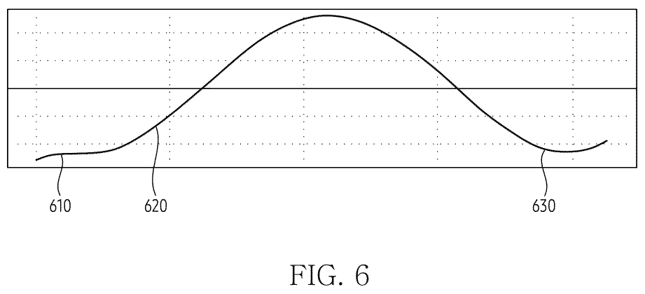

FIG. 6 is a graph indicating data associated with a frequency spectrum according to an embodiment of the disclosure.

The data associated with the frequency spectrum illustrated in FIG. 6 may be generated, for example, by the configuration (e.g., the sensor 20 and the arithmetic unit 30) of FIG. 3. In addition, the data associated with the frequency spectrum illustrated in FIG. 6 may be used to perform the operations of FIGS. 4 and 5. In the graph of FIG. 6, a horizontal axis may indicate a time increasing to the right, and a vertical axis may indicate a frequency component increasing upward.

Referring to FIG. 6, a first section 610 may be a section in which heating starts or an initial heating section. A second section 620 may be a section heated until boiling. A third section 630 may be a section in which the boiling starts. Data associated with a frequency spectrum of the third section 630 may be maintained as a smaller value than the second section 620.

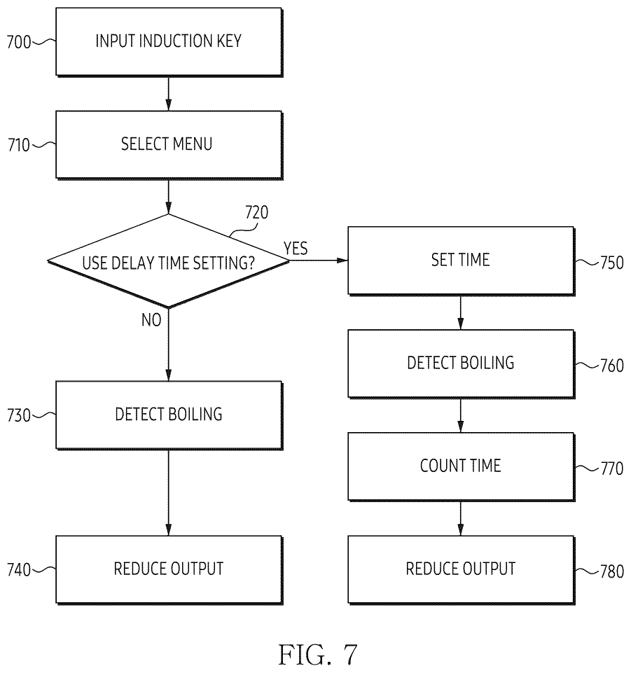

FIG. 7 is a flowchart for describing an operation of a cooking appliance according to an embodiment of the disclosure.

Referring to FIG. 7 together with FIGS. 1 and 3, in operation 700, a controller 60 may receive an input of an induction key. For example, the controller 60 may receive a user input through a button 162 on a panel 160.

In operation 710, the controller 60 may select a menu. For example, the controller 60 may select a menu (e.g., water, soup, or stew) that a user wants to cook based on the user input.

In operation 720, the controller 60 may determine whether to use a delay time setting. For example, whether to use the delay time setting may be preset by a user input. For example, whether to use the delay time setting may be determined by a user input received after performing the operation 810. In operation 720, when the controller 60 determines to use the delay time setting (the operation 720: YES), operation 750 may be performed, otherwise (the operation 720: NO), operation 730 may be performed.

In operation 730, the controller 60 may detect boiling. For example, the controller 60 may detect boiling of a substance in a cooking vessel 25 being heated. For operation 730, the descriptions of the operation S450 of FIG. 4 and the operation S560 of FIG. 5 may be applied in substantially the same manner.

In operation 740, the controller 60 may reduce an output. For example, the controller 60 may reduce an output of an induction coil 10. For the operation 740, the descriptions of the operation S460 of FIG. 4 and the operation S570 of FIG. 5 may be applied in substantially the same manner.

In operation 750, the controller 60 may set a time. For example, the controller 60 may set a time based on a user input inputted through the panel 160.

In operation 760, the controller 60 may detect the boiling (e.g., the operation 730).

In operation 770, the controller 60 may count a time. For example, the controller 60 may count the time set in operation 750.

In operation 780, the controller 60 may reduce the output (e.g., the operation 740). For example, the controller 60 may reduce the output of the induction coil 10 in response to the count of the set time being terminated.

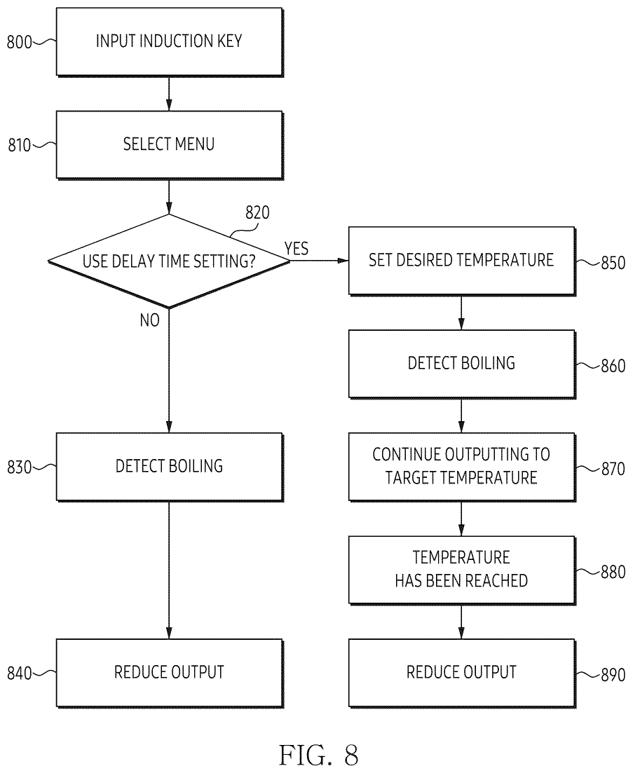

FIG. 8 is a flowchart for describing an operation of a cooking appliance according to an embodiment of the disclosure.

Referring to FIG. 8 together with FIGS. 1 and 3, in operation 800, a controller 60 may receive an input of an induction key. For example, the controller 60 may receive a user input through a button 162 on a panel 160.

In operation 810, the controller 60 may select a menu. For example, the controller 60 may select a menu (e.g., water, soup, or stew) that a user wants to cook based on the user input.

In operation 820, the controller 60 may determine whether to use a temperature setting function. Whether to use the temperature setting function may be preset by a user input. For example, whether to use the temperature setting function may be determined by a user input received after performing the operation 810. In operation 820, when the controller 60 determines to use the temperature setting function (the operation 820: YES), operation 850 may be performed, otherwise (the operation 820: NO), operation 830 may be performed.

In operation 830, the controller 60 may detect boiling. For example, the controller 60 may detect boiling of a substance in a cooking vessel 25 being heated. For the operation 830, the descriptions of the operation S450 of FIG. 4 and the operation S560 of FIG. 5 may be applied in substantially the same manner.

In operation 840, the controller 60 may reduce an output. For example, the controller 60 may reduce an output of an induction coil 10. For the operation 840, the descriptions of the operation S460 of FIG. 4 and the operation S570 of FIG. 5 may be applied in substantially the same manner.

In operation 850, the controller 60 may set a desired temperature. For example, the controller 60 may set the desired temperature based on a user input inputted through the panel 160.

In operation 860, the controller 60 may detect the boiling (e.g., the operation 730).

In operation 870, the controller 60 may continue the output to a target temperature. For example, the controller 60 may maintain the output of the induction coil 10 until the temperature set in operation 850 is reached.

In operation 880, the controller 60 may identify that the target temperature has been reached. For example, the controller 60 may detect a temperature of a top plate 15 using a temperature sensor. The controller 60 may detect that the set temperature has been reached by comparing the detected temperature with the set temperature.

In operation 890, the controller 60 may reduce the output (e.g., the operation 740). For example, in response to detecting that the set temperature has been reached, the controller 60 may reduce the output of the induction coil 10.

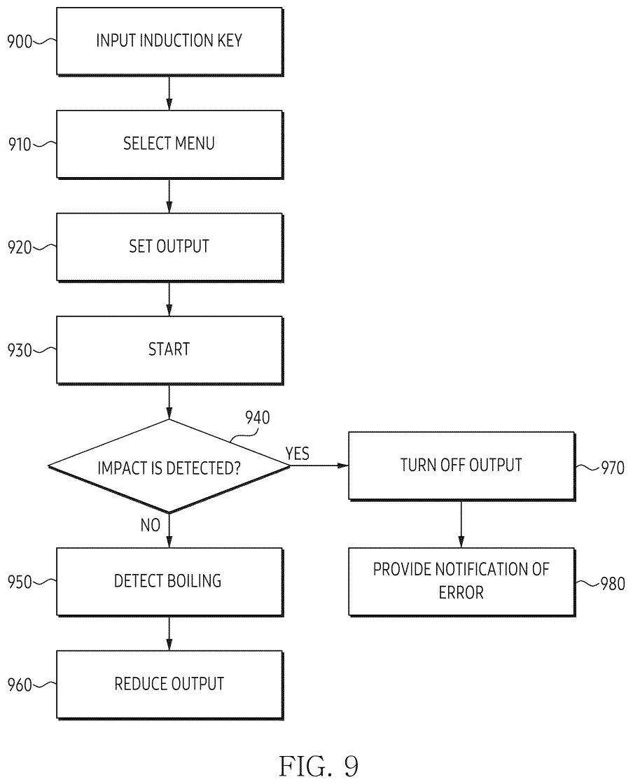

FIG. 9 is a flowchart for describing an operation of a cooking appliance according to an embodiment of the disclosure.

Referring to FIG. 9 together with FIGS. 1 and 3, in operation 900, a controller 60 may receive an input of an induction key. For example, the controller 60 may receive a user input through a button 162 on a panel 160.

In operation 910, the controller 60 may select a menu. For example, the controller 60 may select a menu (e.g., water, soup, or stew) that a user wants to cook based on the user input.

In operation 920, the controller 60 may set an output. For example, in operation 920, the controller 60 may set an output of an induction coil 10 based on the user input received through the panel 160.

In operation 930, the controller 60 may start heating. For example, the controller 60 may control the induction coil 10 to operate with the set output.

In operation 940, the controller 60 may determine whether an impact is detected. For example, the controller 60 may detect an impact on a cooking appliance 1 by using a value detected using a sensor 20. In operation 940, when the controller 60 detects an impact (operation 940: YES), operation 970 may be performed, and otherwise (operation 940: NO), operation 950 may be performed.

In operation 950, the controller 60 may detect boiling. For example, the controller 60 may detect boiling of a substance in a cooking vessel 25 being heated. For the operation 950, the descriptions of the operation S450 of FIG. 4 and the operation S560 of FIG. 5 may be applied in substantially the same manner.

In operation 960, controller 60 may reduce an output. For example, the controller 60 may reduce the output of the induction coil 10. For the operation 960, the descriptions of the operation S460 of FIG. 4 and the operation S570 of FIG. 5 may be applied in substantially the same manner.

In operation 970, the controller 60 may turn off the output. For example, the controller 60 may turn off the output of the induction coil 10 in response to detecting the impact.

In operation 980, the controller 60 may provide a notification of an error. For example, the controller 60 may provide a notification indicating that the error has occurred in response to the output-off of the induction coil 10. For example, the notification may include visual information displayed on a display 161, or a sound outputted through a speaker (not illustrated) of the cooking appliance 1.

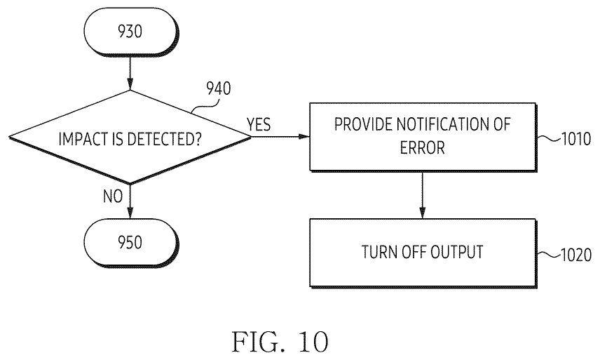

FIG. 10 is a flowchart for describing an operation of a cooking appliance according to an embodiment of the disclosure.

Referring to FIG. 10 together with FIGS. 1 and 3, in operation 940, when a controller 60 detects an impact (operation 940: YES), operation 1010 may be performed, and otherwise (operation 940: NO), operation 950 may be performed.

In operation 1010, the controller 60 may provide a notification of an error. For example, the controller 60 may provide a notification indicating that an error has occurred in response to detecting an impact. For example, the notification may include visual information displayed on a display 161 or a sound outputted through a speaker of a cooking appliance 1.

In operation 1020, the controller 60 may turn off an output. For example, the controller 60 may turn off an output of an induction coil 10 in response to providing the notification.

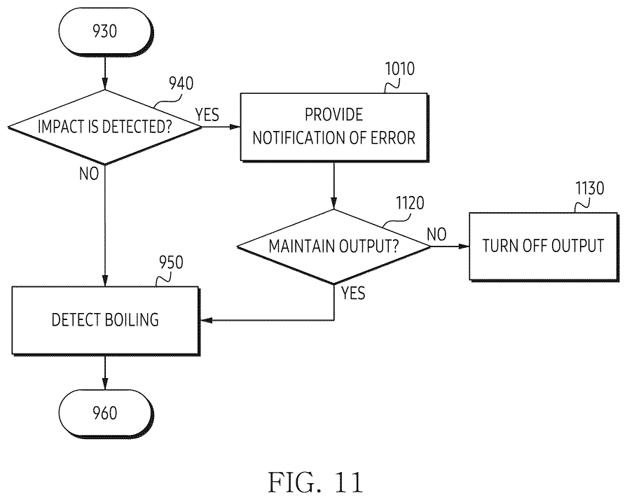

FIG. 11 is a flowchart for describing an operation of a cooking appliance according to an embodiment of the disclosure.

Referring to FIG. 11 together with FIGS. 1 and 3, in operation 1120, a controller 60 may determine whether to maintain an output. For example, the controller 60 may determine whether to maintain an output of an induction coil 10 based on a user input to a panel 160. Optionally, the controller 60 may provide a notification for inducing the user input by asking whether the output is maintained through a display 161 or a speaker.

In operation 1120, when the controller 60 determines to maintain the output (operation 1120: YES), operation 950 may be performed, otherwise operation 1130 may be performed (operation 1120: NO).

In operation 1130, the controller 60 may turn off the output. For example, in response to determining to maintain the output in operation 1120, the controller 60 may turn off the output of the induction coil 10.

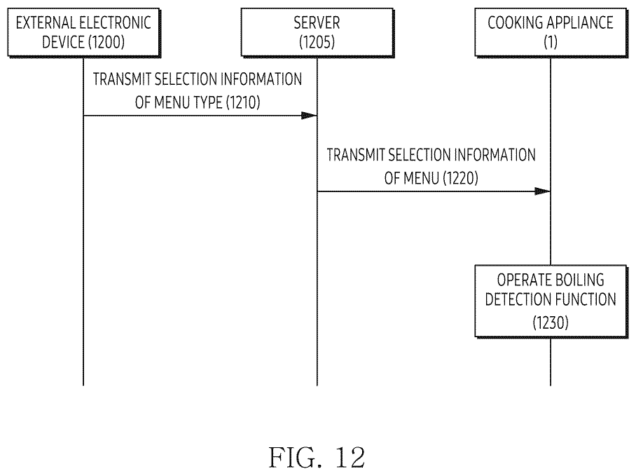

FIG. 12 is a flowchart for describing an operation of a cooking appliance according to an embodiment of the disclosure.

Referring to FIG. 12, an external electronic device 1200 (e.g., a user's mobile device) capable of communicating with a cooking appliance 1 and a server 1205 may be provided. The external electronic device 1200 may transmit selection information of a menu type to the server 1205 (operation 1210). Thereafter, the server 1205 may transmit the selection information of the menu type transmitted from the external electronic device 1200 to the cooking appliance 1 (operation 1220). The cooking appliance 1 may set up a boiling detection function based on the received selection information of the menu type (operation 1230). For example, the cooking appliance 1 may set up the boiling detection function according to a substance (e.g., water, soup, or stew) in a cooking vessel 25 based on the received selection information of the menu type.

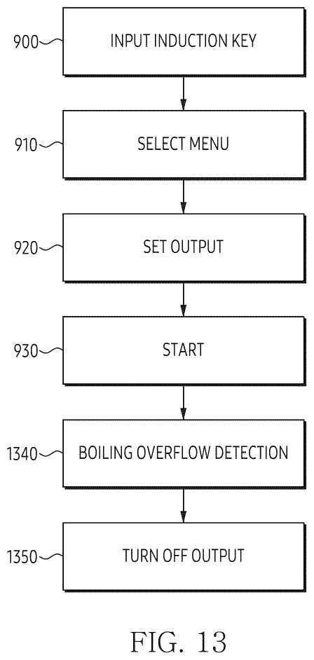

FIG. 13 is a flowchart for describing an operation of a cooking appliance according to an embodiment of the disclosure.

Referring to FIG. 13 together with FIGS. 1 and 3, a controller 60 may detect a boil-over. For example, at operation 1340, the controller 60 may detect that a substance in a cooking vessel 25 overflows over a top plate 15 using a value obtained by a sensor 20.

In operation 1350, the controller 60 may turn off an output. For example, when controller 60 detects the boiling over, the controller 60 may turn off an output of an induction coil 10.

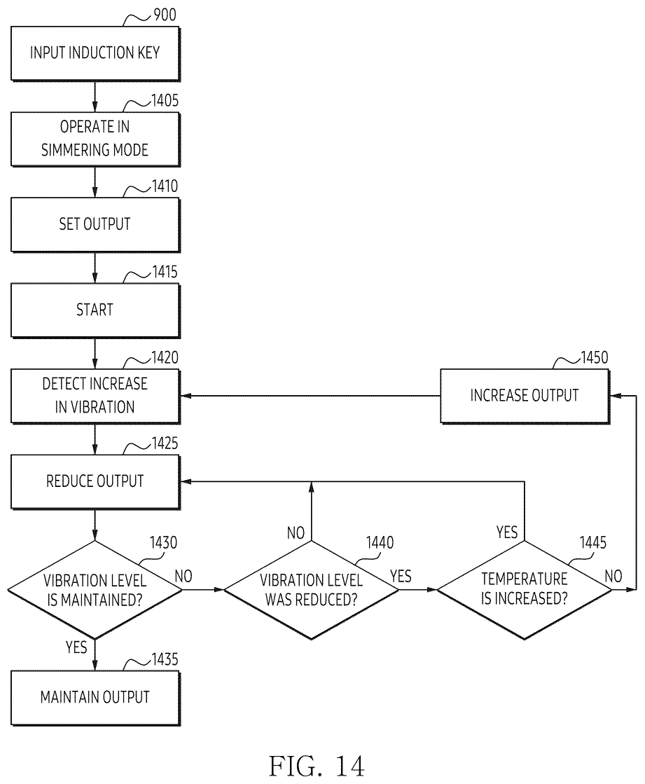

FIG. 14 is a flowchart for describing an operation of a cooking appliance according to an embodiment of the disclosure.

Referring to FIG. 14 together with FIGS. 1 and 3, in operation 1405, a controller 60 may operate in a simmering mode. The simmering mode may be a mode for maintaining a state in which only small bubbles are generated without a liquid in a cooking vessel 25 completely boiling.

In operation 1410, the controller 60 may set an output. For example, in operation 1410, the controller 60 may set an output of an induction coil 10 based on a user input received through a panel 160.

In operation 1415, the controller 60 may start heating. For example, the controller 60 may control the induction coil 10 to operate with the set output.

In operation 1420, the controller 60 may detect an increase in vibration. For example, the controller 60 may detect an increase in vibration of a top plate 15 by using a sensor 20.

In operation 1425, the controller 60 may reduce the output. For example, the controller 60 may reduce the output of the induction coil 10 in response to detecting the increase in the vibration.

In operation 1430, the controller 60 may determine whether a vibration level is maintained. For example, the controller 60 may detect whether the vibration of the top plate 15 is maintained within a specified range using the sensor 20, and may determine according to the detection result. In operation 1430, when the controller 60 determines that the vibration level is maintained (operation 1430: YES), operation 1435 may be performed, and otherwise (operation 1430: NO), operation 1440 may be performed.

In operation 1435, the controller 60 may maintain the output. For example, the controller 60 may maintain the output of the induction coil 10.

In operation 1440, the controller 60 may determine whether the vibration level was reduced. For example, the controller 60 may detect whether the vibration of the top plate 15 was reduced by more than specified magnitude using the sensor 20, and may determine according to the detection result. In operation 1440, when the controller 60 determines that the vibration level is reduced (operation 1440: YES), operation 1445 may be performed, and otherwise (operation 1440: NO), the operation 1425 may be performed.

In operation 1445, the controller 60 may determine whether a temperature is increased. For example, the controller 60 may detect whether a temperature of the top plate 15 (or a heating zone at which the cooking vessel is placed) has increased using the temperature sensor. The controller 60 may determine whether the temperature is increased according to the detection result.

In operation 1445, when the controller 60 determines that the temperature is increased (operation 1445: YES), the operation 1425 may be performed, and otherwise (operation 1440: NO), operation 1450 may be performed.

In operation 1450, the controller 60 may increase the output. The controller 60 may increase the output of the induction coil 10 in response to detecting the increase in the temperature. After performing the operation 1450, the controller 60 may perform the operation 1420.

According to an embodiment, a cooking appliance (e.g., the cooking appliance 1 of FIG. 1) may comprise a top plate (e.g., the top plate 15 of FIG. 1) including a heating zone (e.g., the heating zones 151, 152, and 153 of FIG. 1), an induction coil (e.g., the induction coil 10 of FIG. 3) aligned with the heating zone, an acceleration sensor (e.g., the sensor 20 of FIG. 3) coupled to the top plate, an arithmetic unit (e.g., the arithmetic unit 30 of FIG. 3) for processing sensing data detected by the acceleration sensor, and a processor (e.g., the controller 60 of FIG. 3) for controlling the induction coil, the acceleration sensor, and the arithmetic unit. The processor may be configured to, while the induction coil heats a cooking vessel (e.g., the cooking vessel 25 of FIG. 3) on the heating zone, detect, by the acceleration sensor, a vibration level with respect to the top plate, and obtain, by the arithmetic unit, data associated with a frequency spectrum of the detected vibration level. The processor may be configured to determine at least one reference value for a specific frequency spectrum based on the obtained data. The processor may be configured to, based on the determined at least one reference value, evaluate data associated with a frequency spectrum obtained after determining the at least one reference value. The processor may be configured to identify boiling of a substance in the cooking vessel based on the evaluation. The processor may be configured to control the induction coil based on the identification.

In an embodiment, the processor may be configured to monitor whether the data associated with the obtained frequency spectrum satisfies a specified condition.

In an embodiment, the at least one reference value for the specific frequency spectrum may include a first reference value. The processor may be configured to determine the data associated with the frequency spectrum that satisfies the specified condition as the first reference value.

In an embodiment, the specified condition may be a first specified condition, and the at least one reference value may include a second reference value different from the first reference value. The processor may be configured to monitor whether data associated with a frequency spectrum obtained after determining the first reference value satisfies a second specified condition. The processor may be configured to determine the data associated with the frequency spectrum that satisfies the second specified condition as the second reference value.

In an embodiment, the processor may be configured to monitor whether data associated with a frequency spectrum obtained after determining the second reference value satisfies a third specified condition based at least on the first reference value and the second reference value.

In an embodiment, the cooking appliance may comprise a temperature sensor. The processor may be configured to detect a temperature of the top plate by the temperature sensor after determining the second reference value. The third specified condition may be based on the first reference value, the second reference value, and the temperature of the top plate.

In an embodiment, the processor may be configured to identify the boiling of the substance in the cooking vessel in response to detecting that the data associated with the obtained frequency spectrum satisfies the third specified condition.

In an embodiment, the processor may be configured to reduce an output of the induction coil in response to identifying the boiling of the substance in the cooking vessel.

In an embodiment, the processor may be configured to reduce the output of the induction coil after an elapse of a specified time, in response to identifying the boiling of the substance in the cooking vessel.

In an embodiment, the heating zone may include a plurality of heating zones (e.g., the heating zones 151, 152, and 153 of FIG. 1) arranged along a periphery of an area on the top plate. The acceleration sensor may be configured to detect an acceleration for the area of the top plate or a point within the area.

According to an embodiment, a method of controlling a cooking appliance (e.g., the cooking appliance 1 of FIG. 1) may comprise heating a cooking vessel (e.g., the cooking vessel 25 of FIG. 3) on a top plate (e.g., the top plate 15 of FIG. 3) via an induction coil (e.g., the induction coil 10 of FIG. 3), obtaining data associated with a frequency spectrum of a vibration level for the top plate while heating the cooking vessel, determining at least one reference value for a specific frequency spectrum based on the obtained data, based on the determined at least one reference value, evaluating data associated with a frequency spectrum obtained after determining the at least one reference value, identifying boiling of a substance in the cooking vessel based on the evaluation, and controlling the induction coil based on the identification.

According to an embodiment, the method of controlling may comprise monitoring whether the data associated with the obtained frequency spectrum satisfies a specified condition.

In an embodiment, the at least one reference value for the specific frequency spectrum may include a first reference value. The method of controlling may comprise determining the data associated with the frequency spectrum that satisfies the specified condition as the first reference value.

In an embodiment, the specified condition may be a first specified condition. The at least one reference value may include a second reference value different from the first reference value. The method of controlling may comprise monitoring whether data associated with a frequency spectrum obtained after determining the first reference value satisfies a second specified condition, and determining the data associated with the frequency spectrum that satisfies the second specified condition as the second reference value.

According to an embodiment, the method of controlling may comprise monitoring whether data associated with a frequency spectrum obtained after determining the second reference value satisfies a third specified condition based at least on the first reference value and the second reference value.

According to an embodiment, the method of controlling may comprise detecting a temperature of the top plate by a temperature sensor after determining the second reference value. The third specified condition may be based on the first reference value, the second reference value, and the temperature of the top plate.

According to an embodiment, the method of controlling may comprise identifying the boiling of the substance in the cooking vessel in response to detecting that the data associated with the obtained frequency spectrum satisfies the third specified condition.

In an embodiment, the method of controlling may comprise reducing an output of the induction coil in response to identifying the boiling of the substance in the cooking vessel.

According to an embodiment, the method of controlling may comprise reducing the output of the induction coil after an elapse of a specified time, in response to identifying the boiling of the substance in the cooking vessel.

According to an embodiment, the method of controlling may comprise detecting an impact on the cooking appliance before identifying the boiling of the substance in the cooking vessel and turning off the output of the induction coil in response to detecting the impact.

FIG. 15 is a diagram indicating a configuration of a cooking appliance according to an embodiment of the disclosure. In the following description, reference numbers of other drawings may be referred to.

Referring to FIG. 15, a cooking appliance 1 according to an embodiment may include an induction coil 10, a sensor 20, an arithmetic unit 30, an LDO regulator 40, a voltage level shifter 50, a controller 60, and a temperature sensor 150.

In an embodiment, the temperature sensor 150 may be disposed on a rear surface of a top plate 15 to measure a temperature of a bottom of a cooking vessel. For example, the temperature sensor 150 may be positioned in the coil 10. The temperature sensor 150 may detect a temperature of a heating zone(s) of the top plate 15. The temperature sensor 150 may be electrically connected to the arithmetic unit 30 and/or the controller 60. The controller 60 may obtain temperature information using the temperature sensor 150. The temperature sensor 150 may include, for example, a negative temperature coefficient thermistor or an infrared sensor, but is not limited thereto.

In an embodiment, the temperature sensor 150 may include a plurality of temperature sensors configured to detect a temperature for each of heating zones (e.g., the heating zones 151, 152, and 153 of FIG. 1), but is not limited thereto. For example, the plurality of temperature sensors may be positioned in a specified arrangement for one heating zone 155 as illustrated in FIG. 2, or for another example, the temperature sensor 150 may include only one temperature sensor.

Although not illustrated, the cooking appliance 1 may include a timer (e.g., a timer module or timer circuitry) for measuring a heating time of a cooking vessel 25. The timer may be included or integrated into the controller 60, but is not limited thereto. The controller 60 may obtain information on the heating time of the cooking vessel 25 using the timer. In addition, controller 60 may obtain information on a timing at which an event occurred (e.g., a timing at which boiling is detected) while the timer was operating (e.g., while heating the cooking vessel 25).

In an embodiment, the controller 60 may heat the cooking vessel 25 on the top plate 15 through the induction coil 10. While heating the cooking vessel 25, the controller 60 may detect a temperature using the temperature sensor 150. For example, the controller 60 may detect a temperature for a heating zone of the top plate 15 corresponding to the cooking vessel 25 being heated.

While heating the cooking vessel 25, the controller 60 may detect boiling of a substance in the cooking vessel 25 by using the sensor 20. Since boiling detection uses vibration data of the top plate 15 using the sensor 20, a high-power heating condition may be required to obtain vibration magnitude of bubbles generated in the cooking vessel 25. However, when a soup or stew mixed with ingredients is heated to high-power in a short period of time, a pattern of bubbles varies according to an occurrence of local boiling, a position or a shape of initial solids, and viscosity of the soup, making it difficult to detect boiling. In particular, when the soup or stew is stored in a refrigerator or stored outdoors in winter for a long time, the solids may clump together and settle on a bottom of a vessel or may be transformed like jelly (e.g., bone broth). When this is heated at a high power in a short time, the boiling may not be detected or a premature detection of the boiling may occur since a required vibration value for the boiling detection may not be satisfied as the vibration magnitude of the bubbles becomes small, or since only boiling of some dissolved liquid may cause the boiling to be detected prematurely. According to such non-detection or misdetection of the boiling, the substance in the cooking vessel 25 may be insufficiently heated, and this may cause an inconvenience of a user. According to such non-detection or misdetection of the boiling, the cooking vessel 25 may be excessively heated and contents may boil over. This may cause an energy waste and a safety accident.

To prevent this, the controller 60 may detect a timing and a temperature at which the boiling is detected. The controller 60 may change a heating level of the cooking vessel 25 based on the timing or the temperature at which the boiling is detected. For example, the controller 60 may control the induction coil 10 to change the heating level of the cooking vessel 25 based on the timing or the temperature at which the boiling is detected.

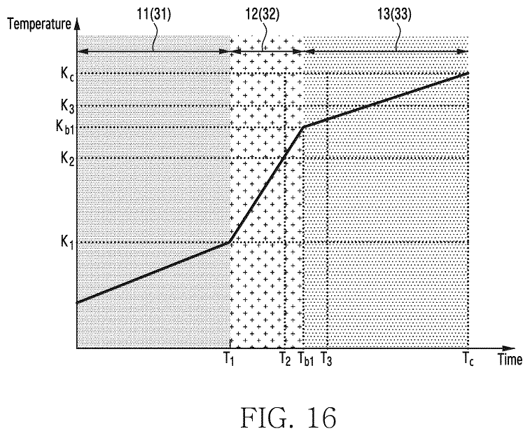

FIGS. 16, 17, 18, and 19 are graphs indicating a temperature of a cooking appliance according to a heating time according to various embodiments of the disclosure.

The temperature illustrated in FIGS. 16, 17, 18, and 19 may be a temperature of a top plate 15 detected using a temperature sensor 150. For example, the temperature illustrated in FIGS. 16, 17, 18, and 19 may correspond to a temperature of a substance on a bottom of a cooking vessel 25 or in the cooking vessel 25.

Hereinafter, an operation in which a controller 60 controls a heating level according to a timing or a temperature at which the boiling is detected will be described with reference to FIGS. 16 to 19.

Referring to FIG. 16, after the initial heating starts, the controller 60 may heat the cooking vessel 25 to a first level 31 during a first period 11. The first level 31 of the first period 11 may be a level 5 among a level 0 to a level 9, but is not limited thereto. By heating the cooking vessel 25 to the first level 31 during the first period 11, a content in a gel form may be completely dissolved, and solid-state solids may be uniformly dispersed in the cooking vessel 25 through an advection of liquid, and a time until a thermal equilibrium between the bottom of the cooking vessel 25 (or the top plate 15) and the substance in the cooking vessel 25 is reached may be secured. Accordingly, an influence of a position and a shape of the solids, viscosity of the soup, and a temperature difference between a temperature of the top plate 15 measured by the temperature sensor 150 and an actual temperature of the substance in the cooking vessel 25 on the boiling detection may be reduced.

An end point of the first period 11 may be defined according to a time or a temperature. For example, the controller 60 may change the heating level from the first level 31 to a second level 32 when the heating time reaches a first timing T₁ or when the temperature reaches a first temperature K₁ after the initial heating is started. Although the graph illustrated in FIG. 16 is illustrated as satisfying both the first timing T₁ and the first temperature K₁, it is not limited thereto, and the heating level may be changed when any one of the first timing T₁ and the first temperature K₁ is reached.

The first timing T₁ may be a predefined value according to a recipe selected by a user. For example, the first timing T-₁ may be a value set such that a temperature of contents has about 30 degrees Celsius to about 40 degrees Celsius according to specific servings (e.g., one serving or two servings), but is not limited thereto. The first temperature K₁ may be determined according to an initial temperature detected through the temperature sensor 150 when the heating starts. For example, when the initial temperature is a room temperature (e.g., about 25 degrees Celsius), the first temperature K₁ may be a value between about 40 degrees Celsius and about 50 degrees Celsius, and when the initial temperature is a temperature lower than the room temperature (e.g., about 5 degrees Celsius), the first temperature K₁ may be a value between about 30 degrees Celsius and about 40 degrees Celsius, but is not limited thereto. The first temperature K₁ may be corrected according to a temperature detected in real time during the first period 11 in consideration of a temperature difference between the temperature of the top plate 15 and the temperature of the bottom of the cooking vessel 25.

The controller 60 may heat the cooking vessel to the second level 32 during a second period 12 after the first period 11. The second level 32 may be different from the first level 31. For example, the second level 32 of the second period 12 may be higher than the first level 31 of the first period 11.

The controller 60 may detect boiling during the second period 12. For example, the controller 60 may detect the boiling at a timing T_{b1} and a temperature K_{b1}. In response to the detection of the boiling, the controller 60 may change the heating level in a third period 13. The heating level in the third period 13 may vary according to a timing or a temperature at which the boiling is detected.

For example, referring to FIG. 16, when the boiling is detected at a timing (e.g., the timing T_{b1}) between a second timing T₂ and a third timing T₃, or at a temperature (e.g., the temperature K_{b1}) between a second temperature K₂ and a third temperature K₃, the controller 60 may heat the cooking vessel 25 to a third level 33, which is different from the second level 32. Although the temperature K_{b1} and the timing T_{b1} at which the boiling is detected are illustrated in the graph of FIG. 16 as satisfying both conditions, it is not limited thereto, and the heating level may be changed from the second level 32 to the third level 33 when any one of the temperature condition or the timing condition is satisfied. The third level 33 may be less than the second level 32 and/or the same as the first level. The second temperature K₂ may be, for example, about 70 degrees Celsius, and the third temperature K₃ may be, for example, about 90 degrees Celsius, but is not limited thereto. The second timing T₂ and the third timing T₃ may be predefined values according to the selected recipe such that the substance in the cooking vessel 25 has about 70 degrees Celsius to about 90 degrees Celsius.

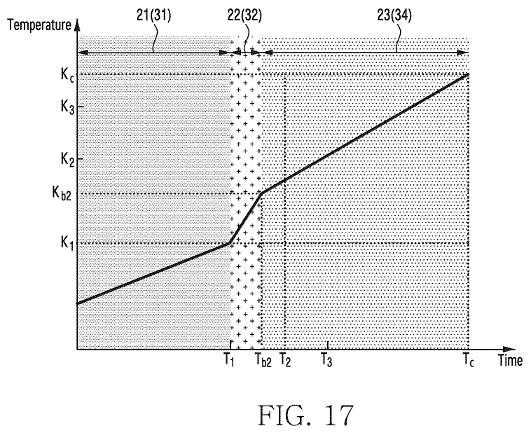

Referring to FIG. 17, when the boiling is detected at a timing (e.g., a timing T_{b2}) between the first timing T₁ and the second timing T₂, or at a temperature (e.g., a temperature K_{b2}) between the first temperature K₋₁ and the second temperature K₂, the controller 60 may heat the cooking vessel 25 to a fourth level 34, which is different from the second level 32. Although the temperature K_{b2} and the timing T_{b2} at which the boiling is detected are illustrated in the graph of FIG. 17 as satisfying both conditions, it is not limited thereto, and the heating level may be changed from the second level 32 to the fourth level 34 when any one of the temperature condition or the timing condition is satisfied. The fourth level 34 may be less than the second level 32 and higher than the first level 31. The fourth level 34 may be higher than the third level 33.

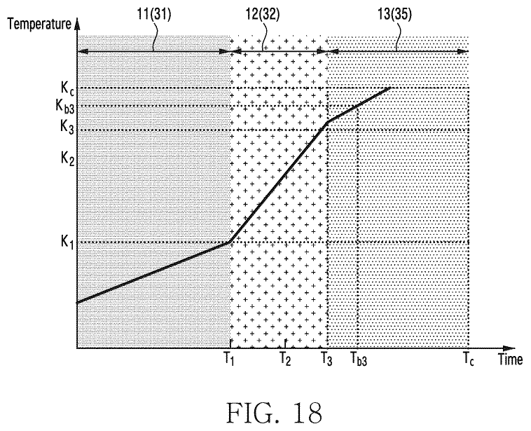

Referring to FIG. 18, according to a characteristic of solids (e.g., solids having a wide shape, such as seaweed), boiling detection may be difficult. In this case, the cooking appliance 1 may compensate for an inability to detect the boiling by using the temperature and timing conditions. For example, when the boiling is not detected until reaching the third timing T₃ and the third temperature K₃, the controller 60 may heat the cooking vessel 25 to a fifth level 35, which is different from the second level 32, in the third period 13. For example, the boiling may be detected at a timing (e.g., a timing T_{b3}) after the third timing T₃ or at a temperature (e.g., a temperature K_{b3}) exceeding the third temperature K₃, or, unlike the illustration, the boiling may not be detected until the heating is finished. In this case, the controller 60 may heat the cooking vessel 25 to the fifth level 35, which is different from the second level 32 in the third period 13. The fifth level 35 may be less than the second level 32 and/or the same as the first level 31.

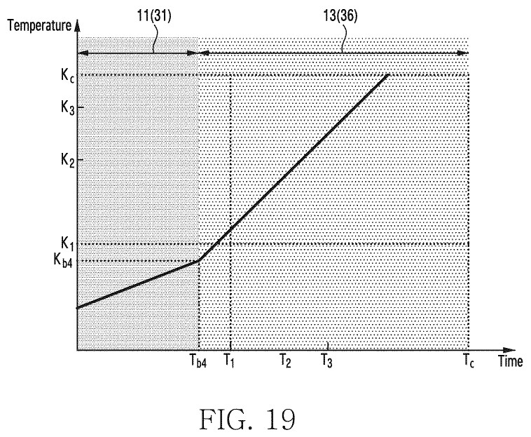

Referring to FIG. 19, the boiling may be detected before satisfying an end condition (e.g., the first timing T₁ or the first temperature K₁) of the first period 11. For example, the boiling may be detected at a timing (e.g., a timing T_{b4}) before the first timing T₁, or at a temperature (e.g., a temperature K_{b4}) less than the first temperature K₁. When an excessive edible powder or solids are included in the cooking vessel 25, or when the substance in the cooking vessel 25 has high viscosity, or when there is a substance generates continuous shocks or vibrations due to heating, the boiling may be erroneously detected before actual boiling occurs. In this case, the controller 60 may heat the cooking vessel 25 to a sixth level 36 different from the first level 31 in the third period 13. The sixth level 36 may be higher than the first level 31. The sixth level 36 may be the same as the fourth level 34 of the third period 13 of FIG. 17, but is not limited thereto.

Referring to FIGS. 16, 17, 18, and 19, an end of the third period 13 may be determined according to a temperature or a timing. For example, the controller 60 may terminate the heating or change the heating level to the minimum level when a threshold temperature K_{C} or a threshold timing T_{C} is reached. Accordingly, it is possible to prevent a safety accident that may occur while continuously heating the cooking vessel 25 because the boiling is not detected. The threshold temperature K_{C} may be, for example, about 100 degrees Celsius. The threshold timing T_{C} may be a preset value according to the selected recipe such that the substance in the cooking vessel 25 approaches about 100 degrees Celsius.

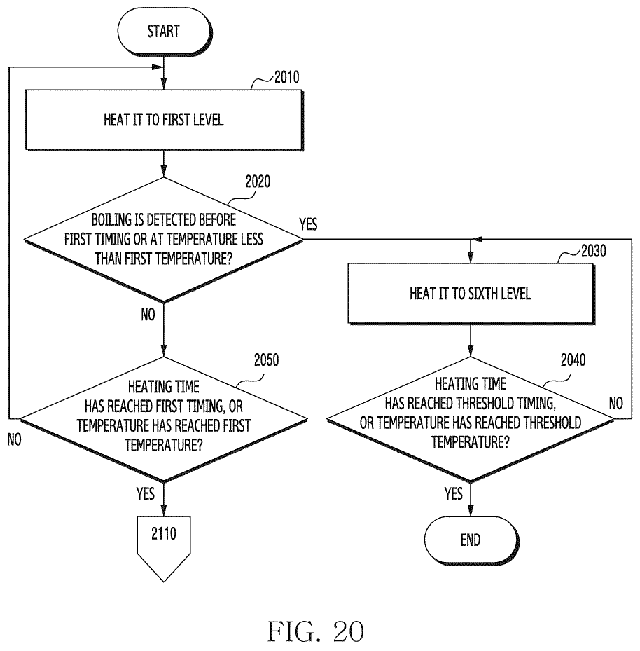

FIGS. 20, 21, 22, and 23 are flowcharts indicating an operation of a cooking appliance for controlling a heat level according to various embodiments of the disclosure.

Referring to FIG. 20, in operation 2010, a controller 60 may heat it to a first level 31. For example, the controller 60 may control the induction coil 10 such that a cooking vessel 25 on a top plate 15 is heated to the first level 31.

In operation 2020, the controller 60 may identify whether boiling is detected before a first timing T₁ or at a temperature less than a first temperature K₁. In operation 2020, when it is identified that boiling is detected before the first timing T₁ or at the temperature less than the first temperature K₁ (operation 2020: YES), operation 2030 may be performed, and otherwise (operation 2020: NO), operation 2050 may be performed.

In operation 2030, the controller 60 may heat it to a sixth level 36. For example, the controller 60 may control the induction coil 10 such that the cooking vessel 25 on the top plate 15 is heated to the sixth level 36.

In operation 2040, the controller 60 may identify whether a heating time has reached a threshold timing T_{C} or whether a temperature has reached a threshold temperature K_{C}. In operation 2040, when it is identified that the heating time has reached the threshold timing T_{C} or the temperature has reached the threshold temperature K_{C} (operation 2040: YES), the controller 60 may terminate the heating. For example, in operation 2040, when it is identified that the heating time has reached the threshold timing T_{C} or the temperature has reached the threshold temperature K_{C}, power of the induction coil 10 may be turned off. Alternatively, in operation 2040, when it is identified that the heating time has reached the threshold timing T_{C} or the temperature has reached the threshold temperature K_{C}, the controller 60 may heat the cooking vessel 25 at the minimum level. In operation 2040, when the threshold timing T_{C} and the threshold temperature K_{C} are not reached (operation 2040: NO), the controller 60 may perform the operation 2030. For example, when the threshold timing T_{C} and the threshold temperature K_{C} are not reached, the controller 60 may maintain the heating level of the cooking vessel 25 to the sixth level 36.

In operation 2050, the controller 60 may identify whether the heating time has reached a first timing T₋₁ or the temperature has reached the first temperature K₁. In operation 2050, when it is identified that the heating time has reached the first timing T₁ or the temperature has reached the first temperature K₁ (operation 2050: YES), operation 2110 may be performed, and otherwise (operation 2050: NO), the operation 2010 may be performed.

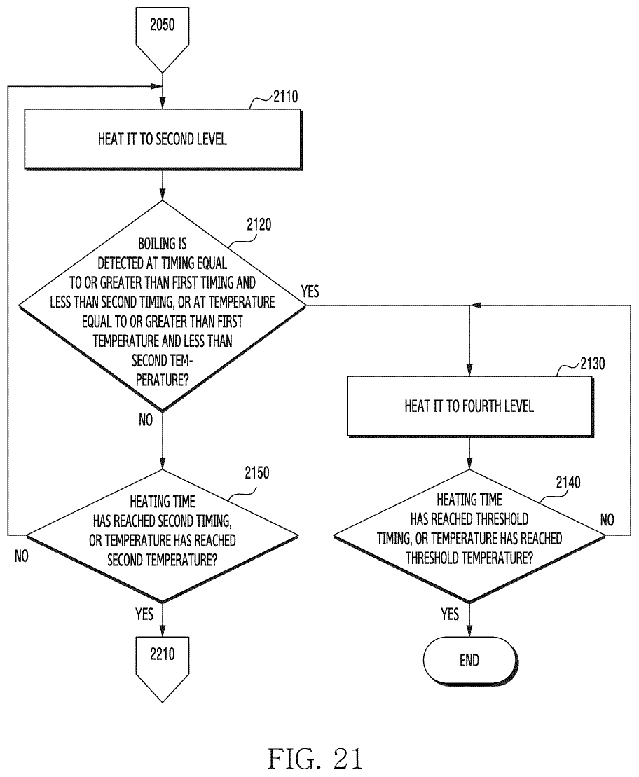

Referring to FIG. 21, in operation 2110, the controller 60 may heat it to a second level 32. For example, the controller 60 may control the induction coil 10 such that the cooking vessel 25 on the top plate 15 is heated to the second level 32.

In operation 2120, the controller 60 may identify whether the boiling is detected at a timing equal to or greater than the first timing T₁ and less than a second timing T₂, or at a temperature equal to or greater than the first temperature K₁ and less than a second temperature K₂. In operation 2120, when the boiling is detected at the timing (e.g., the timing T_{b2} of FIG. 17) equal to or greater than the first timing T₁ and less than the second timing T₂ or at a temperature (e.g., the temperature K_{b2} of FIG. 17) equal to or greater than the first temperature K₁ and less than the second temperature K₂ (operation 2120: YES), operation 2130 may be performed, and otherwise (operation 2120: NO), operation 2150 may be performed.

In operation 2130, the controller 60 may heat it to a fourth level 34. For example, the controller 60 may control the induction coil 10 such that the cooking vessel 25 on the top plate 15 is heated to the fourth level 34.

In operation 2140, the controller 60 may identify whether the heating time has reached the threshold timing TC or the temperature has reached the threshold temperature KC. In operation 2140, when it is identified that the heating time has reached the threshold timing TC or the temperature has reached the threshold temperature KC (operation 2140: YES), the controller 60 may terminate the heating. For example, in operation 2140, when it is identified that the heating time has reached the threshold timing TC or the temperature has reached the threshold temperature KC, the power of the induction coil 10 may be turned off. Alternatively, in operation 2140, when it is identified that the heating time has reached the threshold timing TC or the temperature has reached the threshold temperature KC, the controller 60 may heat the cooking vessel 25 to the minimum level. In operation 2140, when the threshold timing TC and the threshold temperature KC are not reached (operation 2140: NO), the controller 60 may perform the operation 2130. For example, when the threshold timing TC and the threshold temperature KC are not reached, the controller 60 may maintain the heating level of the cooking vessel 25 to the fourth level 34.

In operation 2150, the controller 60 may identify whether the heating time has reached the second timing T₂ or the temperature has reached the second temperature K₂. In operation 2150, when it is identified that the heating time has reached a second timing T₋₂ or the temperature has reached the second temperature K₂ (operation 2150: YES), operation 2210 may be performed, and otherwise (operation 2150: NO), the operation 2110 may be performed.

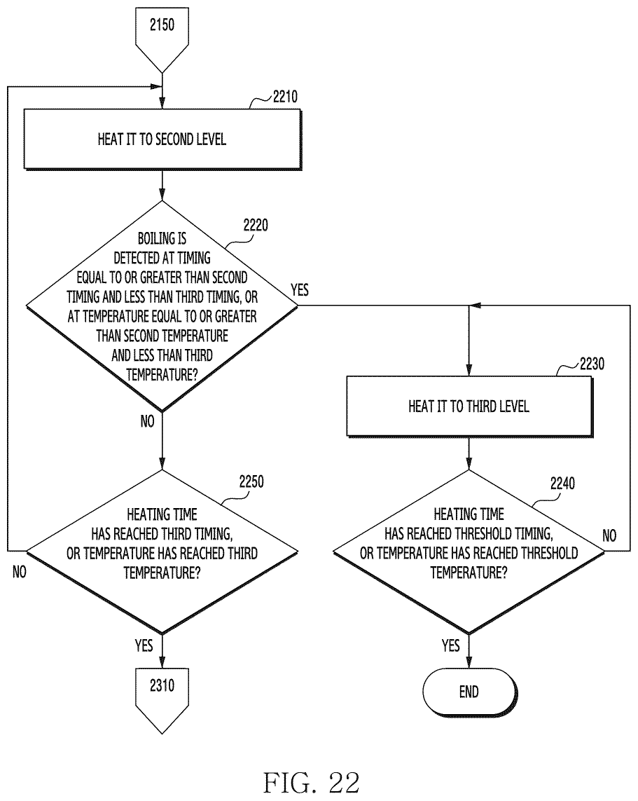

Referring to FIG. 22, in operation 2210, the controller 60 may heat it to the second level 32. For example, the controller 60 may control the induction coil 10 such that the cooking vessel 25 on the top plate 15 is heated to the second level 32.

In operation 2220, the controller 60 may identify whether the boiling is detected at a timing equal to or greater than the second timing T₂ and less than a third timing T₃, or at a temperature equal to or greater than the second temperature K₂ and less than a third temperature K₃. In operation 2220, when it is identified that the boiling is detected at the timing (e.g., the timing T_{b1} of FIG. 16) equal to or greater than the second timing T₂ and less than the third timing T₃, or at the temperature (e.g., the temperature K_{b1} of FIG. 16) equal to or greater than the second temperature K2 and less than the third temperature K3 (operation 2220: YES), operation 2230 may be performed, and otherwise (operation 2220: NO), operation 2250 may be performed.

In operation 2230, the controller 60 may heat it to a third level 33. For example, the controller 60 may control the induction coil 10 such that the cooking vessel 25 on the top plate 15 is heated to the third level 33.

In operation 2240, the controller 60 may identify whether the heating time has reached the threshold timing T_{C} or the temperature has reached the threshold temperature K_{C}. In operation 2240, when it is identified that the heating time has reached the threshold timing T_{C} or the temperature has reached the threshold temperature K_{C} (operation 2240: YES), the controller 60 may terminate the heating. For example, in operation 2240, when it is identified that the heating time has reached the threshold timing T_{C} or the temperature has reached the threshold temperature K_{C}, the power of the induction coil 10 may be turned off. Alternatively, in operation 2240, when it is identified that the heating time has reached the threshold timing T_{C} or the temperature has reached the threshold temperature K_{C}, the controller 60 may heat the cooking vessel 25 at the minimum level. In operation 2240, when the threshold timing T_{C} and the threshold temperature K_{C} are not reached (operation 2240: NO), the controller 60 may perform the operation 2230. For example, when the threshold timing T_{C} and the threshold temperature K_{C} are not reached, the controller 60 may maintain the heating level of the cooking vessel 25 to the third level 33.

In operation 2250, the controller 60 may identify whether the heating time has reached the third timing T₃ or the temperature has reached the third temperature K₃. In operation 2250, when it is identified that the heating time has reached the third timing T₃ or the temperature has reached the third temperature K₃ (operation 2250: YES), operation 2310 may be performed, and otherwise (operation 2250: NO), the operation 2210 may be performed.

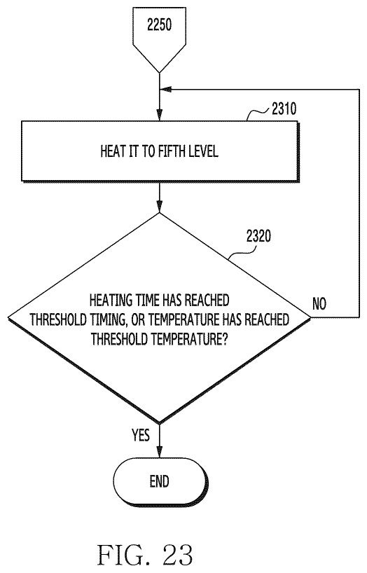

Referring to FIG. 23, in operation 2310, the controller 60 may heat it to a fifth level 35. For example, the controller 60 may control the induction coil 10 such that the cooking vessel 25 on the top plate 15 is heated to the fifth level 35.

In operation 2320, the controller 60 may identify whether the heating time has reached the threshold timing T_{C} or the temperature has reached the threshold temperature K_{C}. In operation 2320, when it is identified that the heating time has reached the threshold timing T_{C} or the temperature has reached the threshold temperature K_{C} (operation 2320: YES), the controller 60 may terminate the heating. For example, in operation 2320, when it is identified that the heating time has reached the threshold timing T_{C} or the temperature has reached the threshold temperature K_{C}, the power of the induction coil 10 may be turned off. Alternatively, in operation 2320, when it is identified that the heating time has reached the threshold timing T_{C} or the temperature has reached the threshold temperature K_{C}, the controller 60 may heat the cooking vessel 25 at the minimum level. In operation 2320, when the threshold timing T_{C} and the threshold temperature K_{C} are not reached (operation 2320: NO), the controller 60 may perform the operation 2310. For example, when the threshold timing T_{C} and the threshold temperature K_{C} are not reached, the controller 60 may maintain the heating level of the cooking vessel 25 to the fifth level 35.

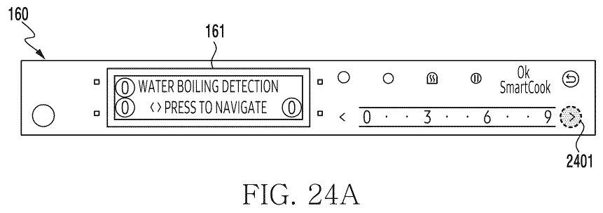

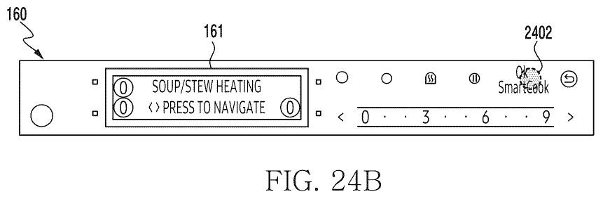

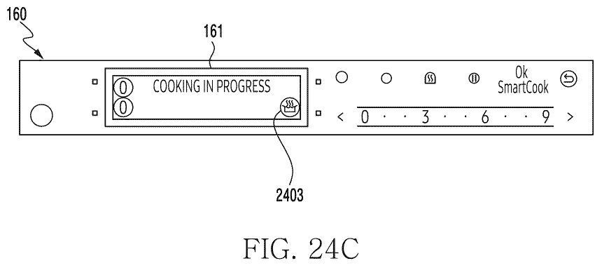

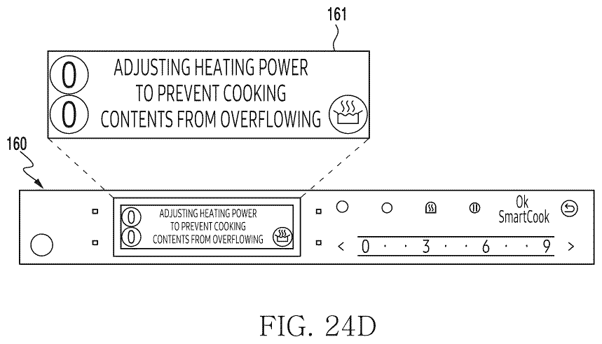

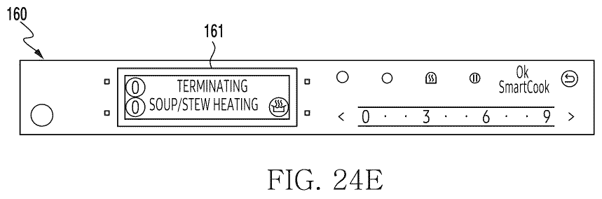

FIGS. 24A, 24B, 24C, 24D, and 24E are diagrams indicating a panel of a cooking appliance according to various embodiments of the disclosure.

Referring to FIG. 24A, a panel 160 may include a display 161. The display 161 may display an object indicating a currently selected menu, such as “water boiling detection,” and an object for guiding a function of a button, such as “<> press to navigate.” Through an input of a button 2401 of the panel 160, the activated menu may be changed.

Referring to FIG. 24B, a menu changed such as ‘Soup/Stew Heating’ may be displayed on the display 161 according to an operation of the button 2401. When an input of a button 2402, such as a confirmation button, is received in a state in which the “Soup/Stew Heating” menu is activated, a cooking appliance 1 may start heating a cooking vessel 25. For example, the cooking appliance 1 may perform the operation 2010 of FIG. 20.

Referring to FIG. 24C, the display 161 may display an object indicating a current operation state, such as “Cooking in Progress,” and an icon 2403 indicating that cooking is currently in progress.

Referring to FIG. 24D, the display 161 may display an object guiding heating power adjustment, such as “Adjusting the heating power to prevent the cooking contents from overflowing.” Such an object may be provided, for example, when a heat level is changed, as in operation 2030 of FIG. 20, the operations 2110 and 2130 of FIG. 21, the operation 2230 of FIG. 22, or the operation 2310 of FIG. 23.

Referring to FIG. 24E, the display 161 may display an object guiding terminating of the heating, such as “Terminating Soup/Stew Heating.” Such an object may be provided, for example, when the operations of FIGS. 20 to 23 are terminated.

According to an embodiment, a cooking appliance 1 may comprise a top plate 15 including a heating zone, an induction coil 10 aligned with the heating zone, at least one sensor, memory comprising at least one storage medium, and a processor 60 comprising processing circuitry. The instructions, when executed individually or collectively by the processor 60, may cause the cooking appliance 1 to heat a cooking vessel 25 on the heating zone of the top plate 15 through the induction coil 10. The instructions, when executed individually or collectively by the processor 60, may cause the cooking appliance 1 to detect boiling of a substance in the cooking vessel 25 and a temperature of the heating zone of the top plate 15 by using the at least one sensor while heating the cooking vessel 25. The instructions, when executed individually or collectively by the processor 60, may cause the cooking appliance 1 to change a heating level of the cooking vessel 25 based on a timing at which the boiling is detected or a temperature detected at the timing.

In an embodiment, the instructions, when executed individually or collectively by the processor 60, may cause the cooking appliance 1 to heat the cooking vessel 25 to a first level (e.g., the first level 31) through the induction coil 10. The instructions, when executed individually or collectively by the processor 60, may cause the cooking appliance 1 to heat the cooking vessel 25 to a second level (e.g., the second level 32) different from the first level, based on identifying that a heating time of the cooking vessel 25 has reached a first timing T₁ or a temperature of the heating zone has reached a first temperature K₁ while heating at the first level.

In an embodiment, the second level may be greater than the first level.

In an embodiment, the instructions, when executed individually or collectively by the processor 60, may cause the cooking appliance 1 to heat the cooking vessel 25 to a third level (e.g., the sixth level 36) different from the first level, based on detecting boiling before the first timing T₁ or detecting boiling at a temperature less than the first temperature K₁ while heating the cooking vessel 25 at the first level.

In an embodiment, the third level may be greater than the first level and less than the second level.

In an embodiment, the instructions, when executed individually or collectively by the processor 60, may cause the cooking appliance 1 to heat the cooking vessel 25 to a fourth level (e.g., the fourth level 34) different from the second level based on detecting the boiling between the first timing T₁ and a second timing T₂ after the first timing T₁ or detecting the boiling at a temperature equal to or greater than the first temperature K₁ and less than a second temperature K₂ while heating at the second level.

In an embodiment, the fourth level may be less than the second level and/or the same as the third level.

In an embodiment, the instructions, when executed individually or collectively by the processor 60, may cause the cooking appliance 1 to heat the cooking vessel 25 to a fifth level (e.g., the second level 32), based on identifying, without detecting the boiling, that the heating time of the cooking vessel 25 has reached the second timing T₂ or the temperature of the heating zone has reached the second temperature K₂ while heating at the second level.

In an embodiment, the fifth level may be the same as the second level.

In an embodiment, the instructions, when executed individually or collectively by the processor 60, may cause the cooking appliance 1 to heat the cooking vessel 25 to a sixth level (e.g., the third level 33) different from the fifth level, based on detecting the boiling between the second timing T2 and a third timing T₃ after the second timing T₂, or detecting the boiling at a temperature equal to or greater than the second temperature K₂ and less than a third temperature K₃ while heating at the fifth level.

In an embodiment, the sixth level may be less than or equal to the fifth level and/or the same as the first level.

In an embodiment, the instructions, when executed individually or collectively by the processor 60, may cause the cooking appliance 1 to heat the cooking vessel 25 to a seventh level (e.g., the fifth level 35) different from the fifth level, based on identifying, without detecting the boiling, that the heating time of the cooking vessel 25 has reached the third timing T₃ or the temperature of the heating zone has reached the third temperature K₃ while heating at the fifth level.

In an embodiment, the seventh level may be less than the fifth level and/or the same as the sixth level.

In an embodiment, the instructions, when executed individually or collectively by the processor 60, may cause the cooking appliance 1 to change the heating level of the cooking vessel 25 to a level less than the first level or to cease to heat the cooking vessel 25, based on identifying that the heating time of the cooking vessel 25 has reached a threshold timing T_{C} or a temperature detected using at the least one sensor has reached a threshold temperature K_{C}.

In an embodiment, a method of controlling of a cooking appliance 1 may comprise heating a cooking vessel 25 on a top plate 15 through an induction coil 10 below the top plate 15, detecting boiling of a substance in the cooking vessel 25 using an acceleration sensor and detecting a temperature corresponding to the substance in the cooking vessel 25 using a temperature sensor while heating the cooking vessel 25, and changing a heating level of the cooking vessel 25 based on a timing at which the boiling is detected or a temperature detected by the temperature sensor at the timing.

In an embodiment, the method may comprise, while heating the cooking vessel 25 to the first level through the induction coil 10, heating the cooking vessel 25 to a second level higher than the first level, based on identifying that the heating time of the cooking vessel 25 has reached a first timing T₁ or that the temperature detected by the temperature sensor has reached a first temperature K₁.

In an embodiment, the method may comprise, while heating the cooking vessel 25 to the first level, heating the cooking vessel 25 to a third level higher than the first level and less than the second level, based on detecting the boiling before the first timing T₁ or detecting the boiling at a temperature less than the first temperature K₁.

In an embodiment, the method may comprise, while heating at the second level, heating the cooking vessel 25 to the third level, based on detecting the boiling between the first timing T₁ and a second timing T₂ after the first timing T₁, or detecting the boiling at a temperature equal to or greater than the first temperature K₁ and less than a second temperature K₂.

In an embodiment, the method may comprise, while heating to the second level, heating the cooking vessel 25 to the first level, based on detecting the boiling between the second timing T₂ and a third timing T₃ after the second timing T₂, or based on identifying that the temperature detected by the temperature sensor has reached a third temperature K₃ greater than the second temperature K₂.

In an embodiment, the method may comprise, based on identifying that the heating time of the cooking vessel 25 has reached a threshold timing T_{C} or that the temperature detected by the temperature sensor has reached a threshold temperature K_{C}, changing the heating level of the cooking vessel 25 to a level less than the first level or ceasing the heating of the cooking vessel 25.

A method according to an embodiment of the disclosure may be implemented in a form of program instructions that may be executed through various computer means and recorded on a computer readable medium. The computer readable medium may include, alone or in combination, program instructions, data files, data structures, and the like. The program instructions recorded on the medium may be specially designed and configured for implementing the disclosure, or may be generally known and available to those skilled in the art of computer software. Examples of the computer readable storage media include magnetic media such as a hard disk, a floppy disk, and a magnetic tape, optical media such as compact disc read-only memory (CD-ROM) and digital versatile disc (DVD, magneto-optical media such as a floptical disk, and hardware devices specially configured to store and execute program instructions, such as read only memory (ROM), random access memory (RAM), and flash memory. Examples of the program instructions include not only machine language code created by a compiler, but also high-level language code that may be executed by a computer using an interpreter or the like.

Partial embodiments of the disclosure may also be implemented in a form of a computer readable medium including instructions that are executable by a computer, such as a program module. The computer readable medium may be any available medium that may be accessed by the computer and may include both volatile and non-volatile media, as well as removable and non-removable media. Further, the computer readable medium may include both a computer storage medium and a communication medium. The computer storage medium include all volatile and non-volatile, removable and non-removable media implemented by any method or technology for storing information such as computer readable instructions, data structures, program modules, or other data. The communication medium typically includes computer readable instructions, data structures, program modules, other data of modulated data signals such as carriers, or other transmission mechanisms, and includes any information transmission medium. In addition, partial embodiments of the disclosure may be implemented as a computer program or a computer program product including instructions executed by the computer, such as a computer-executable computer program.

A computer readable storage medium may be provided in a form of a non-transitory storage medium. Herein, the term “non-transitory storage medium” merely means that the medium is tangible and does not encompass a signal (e.g., an electromagnetic wave), and the term does not distinguish between a case in which data is stored on the medium semi-permanently and a case in which data is stored temporarily. For example, the “non-transitory storage medium” may include a buffer in which data is temporarily stored.

According to an embodiment, a method according to various embodiments disclosed in the document may be provided as portion of the computer program product. The computer program product may be transacted between a seller and a purchaser as a commercial product. The computer program product may be distributed in a form of a computer readable storage medium (e.g., a compact disc read-only memory (CD-ROM)), or may be distributed (e.g., via download or upload) online, either through an application store or directly between two user devices (e.g., smartphones). In the case of online distribution, at least a portion of the computer program product (e.g., a downloadable app) may be at least temporarily stored on, or temporarily generated in, a computer readable storage medium such as memory of a manufacturer's server, an application store server, or an intermediary server.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A cooking appliance comprising:
a top plate including a heating zone;
an induction coil aligned with the heating zone;
an acceleration sensor coupled to the top plate;
an arithmetic unit for processing sensing data detected by the acceleration sensor; and
a processor for controlling the induction coil, the acceleration sensor, and the arithmetic unit,
wherein the processor is configured to, while the induction coil heats a cooking vessel on the heating zone:
detect, by the acceleration sensor, a vibration level with respect to the top plate,
obtain, by the arithmetic unit, data associated with a frequency spectrum of the detected vibration level,
determine at least one reference value for a specific frequency spectrum based on the obtained data,
based on the determined at least one reference value, evaluate data associated with a frequency spectrum obtained after determining the at least one reference value,
identify boiling of a substance in the cooking vessel based on the evaluation, and
control the induction coil based on the identification.

2. The cooking appliance of claim 1, wherein the processor is configured to monitor whether the data associated with the obtained frequency spectrum satisfies a specified condition.

3. The cooking appliance of claim 2,
wherein the at least one reference value for the specific frequency spectrum includes a first reference value, and
wherein the processor is configured to determine the data associated with the frequency spectrum that satisfies the specified condition as the first reference value.

4. The cooking appliance of claim 3,
wherein the specified condition is a first specified condition,
wherein the at least one reference value includes a second reference value different from the first reference value, and
wherein the processor is configured to:
monitor whether data associated with a frequency spectrum obtained after determining the first reference value satisfies a second specified condition, and
determine the data associated with the frequency spectrum that satisfies the second specified condition as the second reference value.

5. The cooking appliance of claim 4, wherein the processor is configured to monitor whether data associated with a frequency spectrum obtained after determining the second reference value satisfies a third specified condition based at least on the first reference value and the second reference value.

6. The cooking appliance of claim 5, further comprising:
a temperature sensor,
wherein the processor is configured to detect a temperature of the top plate by the temperature sensor after determining the second reference value, and
wherein the third specified condition is based on the first reference value, the second reference value, and the temperature of the top plate.

7. The cooking appliance of claim 6, wherein the processor is configured to identify the boiling of the substance in the cooking vessel in response to detecting that the data associated with the obtained frequency spectrum satisfies the third specified condition.

8. The cooking appliance of claim 7, wherein the processor is configured to reduce an output of the induction coil in response to identifying the boiling of the substance in the cooking vessel.

9. The cooking appliance of claim 8, wherein the processor is configured to reduce the output of the induction coil after an elapse of a specified time, in response to identifying the boiling of the substance in the cooking vessel.

10. The cooking appliance of claim 1,
wherein the heating zone includes a plurality of heating zones arranged along a periphery of an area on the top plate, and
wherein the acceleration sensor is configured to detect an acceleration for the area of the top plate or a point within the area.

11. A method of controlling a cooking appliance, the method comprising:
heating a cooking vessel on a top plate via an induction coil;
obtaining data associated with a frequency spectrum of a vibration level for the top plate while heating the cooking vessel;
determining at least one reference value for a specific frequency spectrum based on the obtained data;
based on the determined at least one reference value, evaluating data associated with a frequency spectrum obtained after determining the at least one reference value;
identifying boiling of a substance in the cooking vessel based on the evaluation; and
controlling the induction coil based on the identification.

12. The method of controlling of claim 11, further comprising:
monitoring whether the data associated with the obtained frequency spectrum satisfies a specified condition.

13. The method of controlling of claim 12,
wherein the at least one reference value for the specific frequency spectrum includes a first reference value, and
wherein the method of controlling further comprises determining the data associated with the frequency spectrum that satisfies the specified condition as the first reference value.

14. The method controlling of claim 13,
wherein the specified condition is a first specified condition,
wherein the at least one reference value includes a second reference value different from the first reference value, and
wherein the method of controlling further comprises:
monitoring whether data associated with a frequency spectrum obtained after determining the first reference value satisfies a second specified condition, and
determining the data associated with the frequency spectrum that satisfies the second specified condition as the second reference value.

15. The method of controlling of claim 14, further comprising:
monitoring whether data associated with a frequency spectrum obtained after determining the second reference value satisfies a third specified condition based at least on the first reference value and the second reference value.

16. The control method of claim 15, comprising:
detecting a temperature of the top plate by a temperature sensor after determining the second reference value,
wherein the third specified condition is based on the first reference value, the second reference value, and the temperature of the top plate.

17. The control method of claim 16, comprising:
identifying the boiling of the substance in the cooking vessel in response to detecting that the data associated with the obtained frequency spectrum satisfies the third specified condition.

18. The control method of claim 17, comprising:
reducing an output of the induction coil in response to identifying the boiling of the substance in the cooking vessel.

19. The control method of claim 18, comprising:
detecting an impact on the cooking appliance before identifying the boiling of the substance in the cooking vessel; and
turning off the output of the induction coil in response to detecting the impact.

20. One or more non-transitory computer-readable storage media storing one or more computer programs including computer-executable instructions that, when executed by one or more processors of a cooking appliance individually or collectively, cause the cooking appliance to perform operations, the operations comprising:
heating a cooking vessel on a top plate via an induction coil;
obtaining data associated with a frequency spectrum of a vibration level for the top plate while heating the cooking vessel;
determining at least one reference value for a specific frequency spectrum based on the obtained data;
based on the determined at least one reference value, evaluating data associated with a frequency spectrum obtained after determining the at least one reference value;
identifying boiling of a substance in the cooking vessel based on the evaluation; and
controlling the induction coil based on the identification.
